(19) United States
(12) Patent Application Publication
(10) Pub. No.: US 2010/0164994 A1
(43) Pub. Date: Jul. 1, 2010

(54) CONTENT DISPLAY APPARATUS, CONTENT DISPLAY METHOD, AND CONTENT DISPLAY PROGRAM EMBODIED ON COMPUTER READABLE MEDIUM

(75) Inventor: Kunihiko Sugimoto, Yawata-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Chiyoda-ku (JP)

(21) Appl. No.: 12/645,127

(22) Filed: Dec. 22, 2009

(30) Foreign Application Priority Data
Dec. 25, 2008 (JP) 2008-330451

(51) Int. Cl. G09G 5/00

(52) U.S. Cl. 345/661

(57) ABSTRACT

In order to indicate a position of an object in content even when the object is not being displayed, a PC includes a content display portion to display part of content in a content display area, a setting portion to set an object selected from among a plurality of objects included in the content as a target object, and a marker display portion to display a first marker and a second marker in a first position indication area and a second position indication area, respectively, irrespective of whether or not the target object is being displayed in the content display area. The first and second markers indicate a position within the content where the target object is arranged. The first and second position indication areas are provided separately from the content display area and indicate positions within the content.

This application is based on Japanese Patent Application No. 2008-330451 filed with Japan Patent Office on Dec. 25, 2008, the entire content of which is hereby incorporated by reference.

### BACKGROUND OF THE INVENTION

1. Field of the Invention

The present invention relates to a content display apparatus, a content display method, and a content display program embodied on a computer readable medium. More particularly, the present invention relates to a content display apparatus, a content display method, and a content display program embodied on a computer readable medium configured to display part of content.

2. Description of the Related Art

Recently, programs for editing characters, graphics, or photographs have become widespread, with which the characters, graphics, or photographs can be edited and combined to generate electronic data. In this type of program, the graphics or photographs are managed as objects, and parameters indicating positions, sizes, resolutions, and colors of the respective objects in the content are managed in units of objects. This requires the parameters to be set for each object.

Japanese Patent Laid-Open No. 2003-044867 discloses an illustration generating device having a mouse. The device includes: unit-of-change setting means for setting a unit of change; first display control means for displaying a horizontal information bar and a vertical information bar when an object has been generated, the horizontal information bar having a position and size corresponding to those of the object in the horizontal direction, the vertical information bar having a position and size corresponding to those of the object in the vertical direction; scaling portion for expanding or contracting the horizontal information bar or the vertical information bar in the unit of change that has been set by the unit-of-change setting means, in response to a clicking or dragging operation using the mouse performed at a predetermined portion of the horizontal information bar or the vertical information bar displayed by the first display control means; and changing means for changing the horizontal position and size or the vertical position and size of a bounding box around a selected object, in accordance with the expansion or contraction of the horizontal information bar or the vertical information bar by the scaling means.

In the conventional illustration generating device, the horizontal information bar and the vertical information bar displayed in correspondence with the object being displayed can be expanded or contracted so as to change the size of the object. However, in order to cause a first object being displayed and a second object not being displayed to have a same horizontal or vertical position or a same size, it is necessary to perform setting operations separately for the first and second objects. That is, the position or size of the first object being displayed has to be remembered first, and the second object then needs to be displayed so as to set the position or size of the second object to conform to that of the first object.

As such, troublesome operations are required for setting same parameters for two or more objects.

### SUMMARY OF THE INVENTION

The present invention has been accomplished in view of the foregoing problem, and an object of the present invention is to provide a content display apparatus which can show a position in content of an object that is not being displayed.

Another object of the present invention is to provide a content display method which enables showing of a position in content of an object that is not being displayed.

A further object of the present invention is to provide a content display program embodied on a computer readable medium which enables showing of a position in content of an object that is not being displayed.

To achieve the above-described objects, according to an aspect of the present invention, a content display apparatus includes: a content display portion to display part of content in a display area; a setting portion to set an object selected from among a plurality of objects included in the content as a target object; and a marker display portion to display, in a position indication area, a marker indicating a position within the content where the target object is arranged, irrespective of whether or not the target object is being displayed in the display area, the position indication area being provided separately from the display area and indicating positions within the content.

According to another aspect of the present invention, a content display method includes the steps of: displaying part of content in a display area; setting an object selected from among a plurality of objects included in the content as a target object; and displaying, in a position indication area, a marker indicating a position within the content where the target object is arranged, irrespective of whether or not the target object is being displayed in the display area, the position indication area being provided separately from the display area and indicating positions within the content.

According to a further aspect of the present invention, a content display program embodied on a computer readable medium causes a computer to perform the steps of: displaying part of content in a display area; setting an object selected from among a plurality of objects included in the content as a target object; and displaying, in a position indication area, a marker indicating a position within the content where the target object is arranged, irrespective of whether or not the target object is being displayed in the display area, the position indication area being provided separately from the display area and indicating positions within the content.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing an example of the hardware configuration of a PC according to an embodiment of the present invention.

FIG. 2 is a functional block diagram schematically showing the functions of a CPU included in the PC.

FIG. 3 shows an example of a display screen.

FIG. 4 is a flowchart illustrating an example of the flow of a content display process.

FIG. 5 is a flowchart illustrating an example of the flow of a horizontal position/length moving/changing process.

FIG. 6 is a flowchart illustrating an example of the flow of a vertical position/length moving/changing process.

FIG. 7 shows an example of a collective change instructing screen.

FIG. 8 shows an example of a first position indication area where a plurality of first markers are displayed in different colors.

FIG. 9 shows an example of the first position indication area where a plurality of first markers are displayed so as not to overlap each other.

FIG. 10 shows another example of the first position indication area where the plurality of first markers are displayed so as not to overlap each other.

### DESCRIPTION OF THE PREFERRED EMBODIMENTS

Embodiments of the present invention will now be described with reference to the drawings. In the following description, like reference characters denote like parts, which have like names and functions, and therefore, detailed description thereof will not be repeated. In the following, a personal computer (hereinafter, referred to as a “PC”) is described as an example of a content display apparatus.

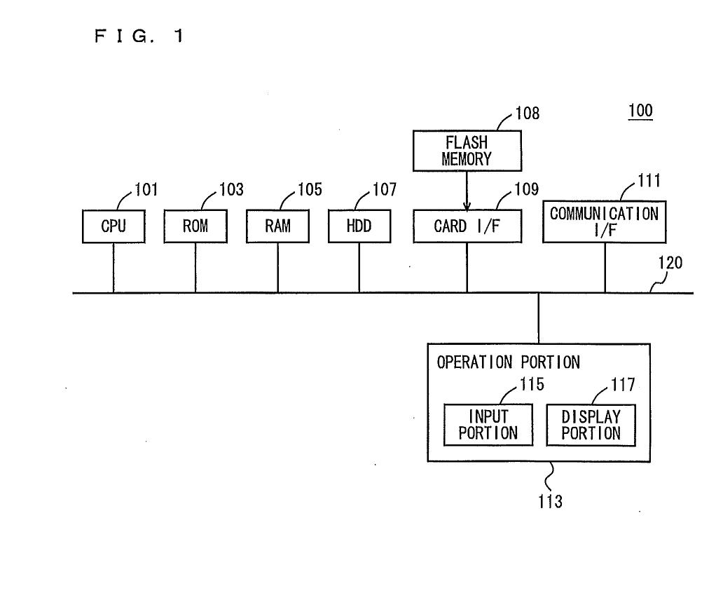

FIG. 1 is a block diagram showing an example of the hardware configuration of a PC according to an embodiment of the present invention. Referring to FIG. 1, a PC 100 includes: a central processing unit (CPU) 101, a read only memory (ROM) 103 which stores a program executed by CPU 101 and others, a random access memory (RAM) 105 used as a work area for CPU 101, a hard disk drive (HDD) 107 as a mass storage device, a communication interface (I/F) 111 through which PC 100 is connected to the Internet, an operation portion 113 which functions as an interface with a user, a card interface (I/F) 109 mounted with a flash memory 108, and a bus 120 to which the above elements are connected.

CPU 101 is responsible for overall control of PC 100. CPU 101 executes a content display program stored in ROM 103. Alternatively, CPU 101 may load the content display program stored in flash memory 108 via card I/F 109 into RAM 105 for execution.

Operation portion 113 includes an input portion 115 having a keyboard and a pointing device such as a mouse, and a display portion 117 made up of a liquid crystal display or the like for displaying data. Display portion 117 may be an organic electro-luminescence display (ELD), a cathode ray tube, or the like, besides the liquid crystal display.

It is noted that the recording medium for storing the program to be executed by CPU 101 is not restricted to flash memory 108. It may be a flexible disk, a cassette tape, an optical disc (compact disc-ROM (CD-ROM), magneto-optical (MO) disc, mini disc (MD), digital versatile disc (DVD)), an IC card, an optical card, or a semiconductor memory such as a mask ROM, an erasable and programmable ROM (EPROM), an electrically erasable and programmable ROM (EEPROM), or the like.

Still alternatively, CPU 101 may download the content display program from a computer connected to the Internet and store the program in HDD 107, or a computer connected to the Internet may write the content display program to HDD 107, and thereafter, CPU 101 may execute the program. As used herein, the “content display program” includes, not only the program which CPU 101 can execute directly, but also a source program, a compressed program, an encrypted program, and others.

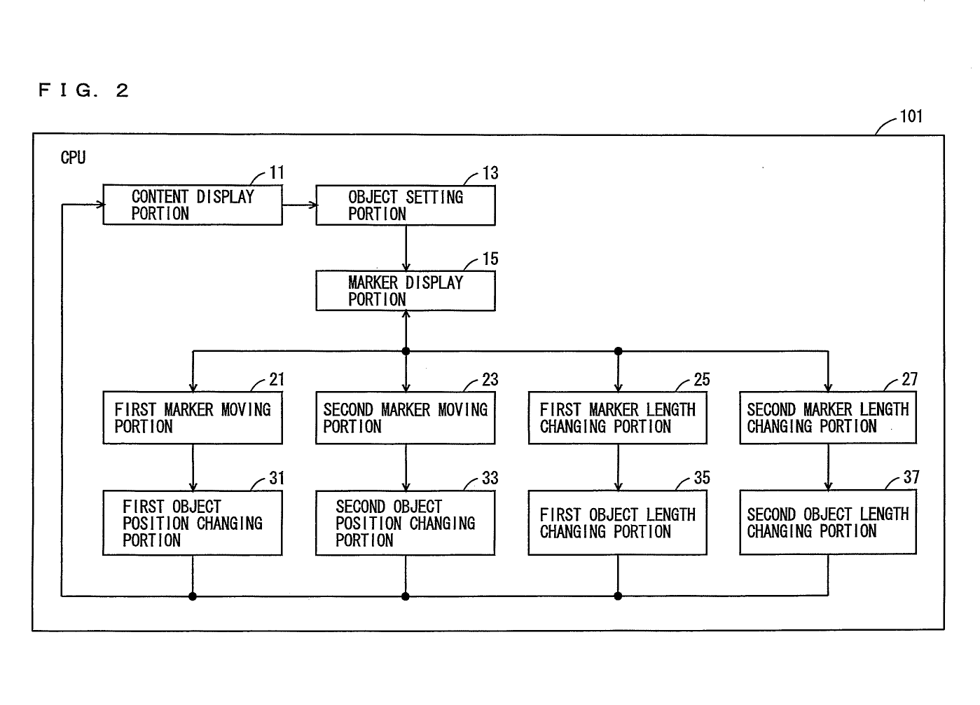

FIG. 2 is a functional block diagram schematically showing the functions of the CPU included in the PC. Referring to FIG. 2, CPU 101 includes: a content display portion 11 which displays content; an object setting portion 13 which sets a target object to be processed, from among a plurality of objects included in the content; a marker display portion 15 which displays a marker indicating a position in the content where the target object is arranged; a first marker moving portion 21 which moves a first marker, the first marker corresponding to a first direction of the target object; a second marker moving portion 23 which moves a second marker, the second marker corresponding to a second direction of the target object; a first marker length changing portion 25 which changes a length in the first direction of the first marker; a second marker length changing portion 27 which changes a length in the second direction of the second marker; a first object position changing portion 31 which moves the target object in the first direction; a second object position changing portion 33 which moves the target object in the second direction; a first object length changing portion 35 which changes a length in the first direction of the target object; and a second object length changing portion 37 which changes a length in the second direction of the target object.

Content display portion 11 reads from HDD 107 the content designated by a user, and displays the read content on display portion 117. A display screen displayed on display portion 117 by content display portion 11 includes a content display area for displaying the content, and a position indication area for indicating positions within the content. Content display portion 11 displays the content in the content display area in the display screen. In the case where the display size of the content is larger than the content display area, content display portion 11 displays part of the content. Content display portion 11 changes the part of the content displayed in the content display area by accepting a scroll operation by the user.

In the state where the content is being displayed in display portion 117, when the user inputs to input portion 115 an operation to select an object included in the content being displayed, object setting portion 13 sets the object specified by the selecting operation as a target object.

The object refers to a part which is used as a unit of processing when an application program displays or edits the content. The unit of processing includes a minimum part that cannot be divided any more, and includes a group as a combination of a plurality of such minimum parts. The objects may include a text-entry field, a straight line, an arrow, a circle, a semicircle, a curved line, a rectangle, a triangle, and other figures, as well as a part for use in drawing a flowchart, a part for use in creating a circuit diagram, an image such as a photograph, a table, a speech balloon, and others.

When the user inputs a plurality of operations to select a plurality of objects, object setting portion 13 sets the plurality of objects specified by the operations as the target objects. Object setting portion 13 outputs the plurality of target objects set by object setting portion 13, to marker display portion 15.

Marker display portion 15 displays at least one marker corresponding respectively to the at least one target object input from object setting portion 13, in the position indication area within the display screen being displayed in display portion 117. Here, the position indication area includes a first position indication area for indicating positions in a horizontal direction (first direction) in the content, and a second position indication area for indicating positions in a vertical direction (second direction) in the content.

Marker display portion 15 displays, in the first position indication area, a first marker indicating a horizontal position in the content of a target object, and displays, in the second position indication area, a second marker indicating a vertical position in the content of the target object. Marker display portion 15 displays the first and second markers in the first and second position indication areas, respectively, irrespective of whether or not the target object is included in the content display area on the display screen being displayed in display portion 117. Thus, even in the case where the target object is not being displayed in display portion 117, the first and second markers corresponding to that target object are displayed in the first and second position indication areas, respectively. In the case where a plurality of target objects are input from object setting portion 13, marker display portion 15 displays in the first position indication area a plurality of first markers corresponding respectively to the plurality of target objects, and displays in the second position indication area a plurality of second markers corresponding respectively to the plurality of target objects.

The display screen for displaying content will now be described. It is here assumed that the content includes first through third pages, that the first through third pages include first through third objects, respectively, and that the first through third objects have been set as the target objects.

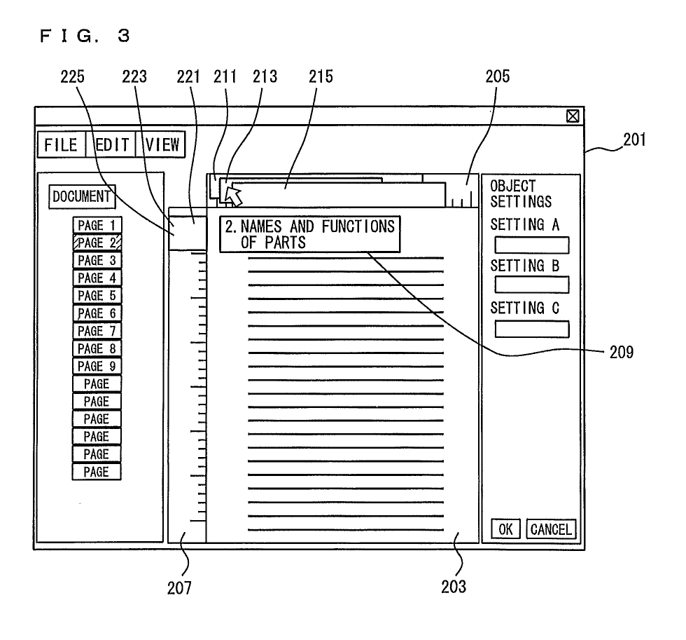

FIG. 3 shows an example of the display screen. Referring to FIG. 3, a display screen 201 includes: a content display area 203 in which content is displayed; a first position indication area 205 in which positions in the horizontal direction (first direction) in the content are indicated; and a second position indication area 207 in which positions in the vertical direction (second direction) in the content are indicated. FIG. 3 shows the state where the second page of the content is being displayed in content display area 203, and in content display area 203, a second object 209 included in the second page of the content is being displayed.

A first marker 213 and a second marker 223 corresponding to second object 209 as the target object are displayed in first position indication area 205 and second position indication area 207, respectively. In first position indication area 205, a first marker 211 corresponding to the first object included in the first page and a first marker 215 corresponding to the third object included in the third page are displayed as well. Further, in second position indication area 207, a second marker 221 corresponding to the first object included in the first page and a second marker 225 corresponding to the third object included in the third page are displayed as well.

Although the first object included in the first page and the third object included in the third page are not being displayed in content display area 203, first markers 211 and 215 and second markers 221 and 225 corresponding to the first and third objects are displayed in first position indication area 205 and second position indication area 207. Accordingly, for second object 209 included in the second page, its horizontal position within the second page can be confirmed in first position indication area 205, and at the same time, the horizontal position within the first page of the first object and the horizontal position within the third page of the third object can also be confirmed in first position indication area 205. This allows the horizontal position within the second page of second object 209 to be compared with the horizontal positions within the first and third pages of the first and third objects, respectively.

Similarly, for second object 209 included in the second page, its vertical position within the second page can be confirmed in second position indication area 207, and at the same time, the vertical position within the first page of the first object and the vertical position within the third page of the third object can also be confirmed in second position indication area 207. Accordingly, it is possible to compare the vertical position within the second page of second object 209 with the vertical positions within the first and third pages of the first and third objects. In this example, second markers 221, 223, and 225 are in the same position in the vertical direction, indicating that the first through third objects are arranged vertically in the same position in the first through third pages, respectively.

Returning to FIG. 2, first marker moving portion 21 moves first markers 211, 213, and 215 displayed in first position indication area 205 within that area. Specifically, when a user operates the mouse included in input portion 115 to move the mouse pointer onto one of first markers 211, 213, and 215 and drag the mouse pointer while pressing and holding the mouse button, then first marker moving portion 21 accepts the dragged one of first markers 211, 213, and 215 as a target to be moved, and accepts the last position of the mouse pointer as the horizontal position to which the target is to be moved, or the destination of the target. Here, it is assumed that first marker 211 has been accepted as the target to be moved. First marker moving portion 21 moves first marker 211 accepted as the target to be moved, to the position accepted as the destination of the target. In this case, the shape of first marker 211 is not changed. First marker moving portion 21 outputs information for identifying first marker 211 accepted as the target to be moved and the horizontal position accepted as the destination of the target, to first object position changing portion 31 and marker display portion 15. Marker display portion 15 displays first marker 211 specified by the information for identifying first marker 211, input from first marker moving portion 21, at the horizontal position as the destination of the target, input from first marker moving portion 21.

First object position changing portion 31 receives from first marker moving portion 21 the information for identifying first marker 211 and the horizontal position as the destination of the target. First object position changing portion 31 specifies the first object on the basis of the information for identifying first marker 211, and arranges the first object within the first page in accordance with the horizontal position input from first marker moving portion 21 as the destination of the target. First object position changing portion 31 then outputs to content display portion 11 information indicating that the content has been changed. When content display portion 11 receives from first object position changing portion 31 the information indicating that the content has been changed, content display portion 11 re-displays the content that has been displayed so far. Here, the position of the first object has been changed, and no change has been made to the second page that is being displayed by content display portion 11. Thus, the re-displayed content remains unchanged from the previously displayed content. For example in the case where the position of second object 209 is changed, the second page having second object 209 changed in position is displayed.

Second marker moving portion 23 moves second markers 221, 223, and 225 displayed in second position indication area 207 within that area. Specifically, when a user operates the mouse included in input portion 115 to move the mouse pointer onto one of second markers 221, 223, and 225 and drag the mouse pointer while pressing and holding the mouse button, then second marker moving portion 23 accepts the dragged one of second markers 221, 223, and 225 as a target to be moved, and accepts the last position of the mouse pointer as the vertical position to which the target is to be moved, or the destination of the target. Here, it is assumed that second marker 221 has been accepted as the target to be moved. Second marker moving portion 23 moves second marker 221 accepted as the target to be moved, to the position accepted as the destination of the target. In this case, the shape of second marker 221 is not changed. Second marker moving portion 23 outputs information for identifying second marker 221 accepted as the target to be moved and the vertical position accepted as the destination of the target, to second object position changing portion 33 and marker display portion 15. Marker display portion 15 displays second marker 221 specified by the information for identifying second marker 221, input from second marker moving portion 23, at the vertical position as the destination of the target, input from second marker moving portion 23.

Second object position changing portion 33 receives from second marker moving portion 23 the information for identifying second marker 221 and the horizontal position as the destination of the target. Second object position changing portion 33 specifies the first object on the basis of the information for identifying second marker 221, and arranges the first object within the first page in accordance with the vertical position input from second marker moving portion 23 as the destination of the target. Second object position changing portion 33 then outputs to content display portion 11 information indicating that the content has been changed. When content display portion 11 receives from second object position changing portion 33 the information indicating that the content has been changed, content display portion 11 re-displays the content that has been displayed so far. Here, the position of the first object has been changed, and no change has been made to the second page that is being displayed by content display portion 11. Thus, the re-displayed content remains unchanged from the previously displayed content. For example in the case where the position of second object 209 is changed, the second page having second object 209 changed in position is displayed.

First marker length changing portion 25 changes horizontal lengths of first markers 211, 213, and 215 displayed in first position indication area 205 within that area. Specifically, when the user operates the mouse in input portion 115 to place the mouse pointer on one of horizontal ends of any of first markers 211, 213, and 215 and drag the mouse pointer while pressing and holding the mouse button, then first marker length changing portion 25 accepts the one of first markers 211, 213, and 215 whose end has been dragged by the mouse as a target whose length is to be changed, and accepts the last position of the mouse pointer as the changed position of the end that has been dragged. Here, it is assumed that the right end of first marker 211 has been dragged with the mouse, and thus, first marker 211 has been accepted as the target whose length is to be changed. First marker length changing portion 25 changes the length of first marker 211 accepted as the target whose length is to be changed, by changing the position of its right end to the position accepted as the changed position thereof, without changing the position of its left end.

First marker length changing portion 25 outputs information for identifying first marker 211 accepted as the target whose length is to be changed, and the changed positions of its horizontal ends, to first object length changing portion 35 and marker display portion 15. Marker display portion 15 displays first marker 211 specified by the information for identifying first marker 211, input from first marker length changing portion 25, in the length specified by the changed positions of its horizontal ends, input from first marker length changing portion 25.

First object length changing portion 35 receives from first marker length changing portion 25 the information for identifying first marker 211 and the changed positions of its horizontal ends. First object length changing portion 35 specifies the first object, on the basis of the information for identifying first marker 211, and changes the length of the first object within the first page to the length specified by the changed positions of the horizontal ends, input from first marker length changing portion 25. Thereafter, first object length changing portion 35 outputs to content display portion 11 information indicating that the content has been changed. When content display portion 11 receives from first object length changing portion 35 the information indicating that the content has been changed, content display portion 11 re-displays the content that has been displayed so far. Here, the length of the first object has been changed, and no change has been made to the second page being displayed by content display portion 11. Thus, the re-displayed content remains unchanged from the previously displayed content. For example in the case where the length of second object 209 is changed, the second page having second object 209 changed in length is displayed.

Second marker length changing portion 27 changes vertical lengths of second markers 221, 223, and 225 displayed in second position indication area 207 within that area. Specifically, when the user operates the mouse in input portion 115 to place the mouse pointer on one of vertical ends of any of second markers 221, 223, and 225 and drag the mouse pointer while pressing and holding the mouse button, then second marker length changing portion 27 accepts the one of second markers 221, 223, and 225 whose end has been dragged by the mouse as a target whose length is to be changed, and accepts the last position of the mouse pointer as the changed position of the dragged end. Here, it is assumed that the lower end of second marker 221 has been dragged with the mouse, and thus, second marker 221 has been accepted as the target whose length is to be changed. Second marker length changing portion 27 changes the length of second marker 221 accepted as the target whose length is to be changed, by changing the position of the lower end to the position accepted as the changed position thereof, without changing the position of the upper end. Second marker length changing portion 27 outputs information for identifying second marker 221 accepted as the target whose length is to be changed, and the changed positions of its vertical ends, to second object length changing portion 37 and marker display portion 15. Marker display portion 15 displays second marker 221 specified by the information for identifying second marker 221, input from second marker length changing portion 27, in the length specified by the changed positions of its vertical ends, input from second marker length changing portion 27.

Second object length changing portion 37 receives from second marker length changing portion 27 the information for identifying second marker 221 and the changed positions of its vertical ends. Second object length changing portion 37 specifies the first object, on the basis of the information for identifying second marker 221, and changes the length of the first object within the first page to the length specified by the changed positions of the vertical ends, input from second marker length changing portion 27. Thereafter, second object length changing portion 37 outputs to content display portion 11 information indicating that the content has been changed. When content display portion 11 receives from second object length changing portion 37 the information indicating that the content has been changed, content display portion 11 re-displays the content that has been displayed so far. Here, the length of the first object has been changed, and no change has been made to the second page being displayed by content display portion 11. Thus, the re-displayed content remains unchanged from the previously displayed content. For example in the case where the length of second object 209 is changed, the second page having second object 209 changed in length is displayed.

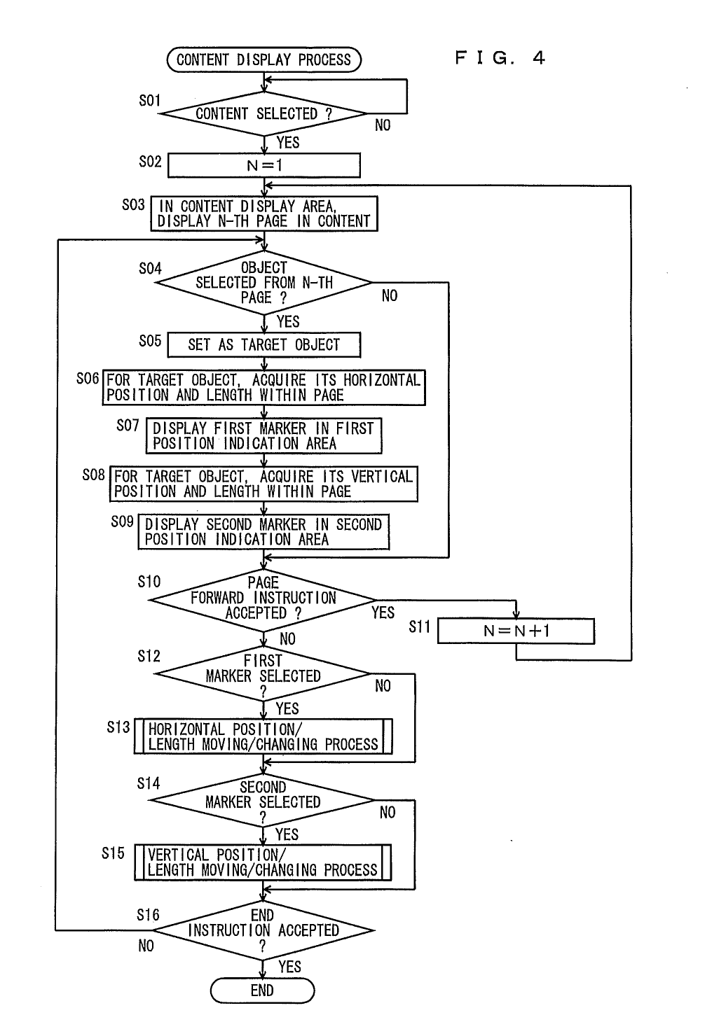

FIG. 4 is a flowchart illustrating an example of the flow of a content display process. The content display process is carried out by CPU 101 included in PC 100 as CPU 101 executes a content display program. Referring to FIG. 4, CPU 101 determines whether content has been selected (step S01). CPU 101 is in a standby mode until content is selected (NO in step S01), and once the content is selected, the process proceeds to step S02. Specifically, when the user operates input portion 115 to designate one of a plurality of content items stored in HDD 107, it is determined that content has been selected, and the designated content is selected. In other words, the content display process is carried out on the condition that the content to be displayed has been selected.

In step S02, a variable N is set to “1”, and the process proceeds to step S03. For variable N, the page number is set so as to specify one of a plurality of pages included in the content selected in step S01.

In step S03, the N-th page of the content selected in step S01 is displayed in content display area 203 in display screen 201. In this case, whole or part of the N-th page may be displayed in content display area 203. As content display area 203 has a fixed display area, the portion that can be displayed therein is determined depending on the magnification which is set for the content.

In step S04, it is determined whether an object included in the N-th page has been selected. If an object has been selected, the process proceeds to step S05; otherwise, the process proceeds to step S10. When the mouse pointer is placed on an object being displayed in content display area 203 and a right click operation is accepted, then the object on which the mouse pointer has been placed is selected.

In the following step S05, the selected object is set as a target object. Specifically, a context menu is displayed, and when a menu for setting a target object is designated in the context menu, the selected object is set as the target object.

In the following step 506, for the object that has been set as the target object, the horizontal position and horizontal length within the page are acquired. Then, in step 507, a first marker is displayed in first position indication area 205. Specifically, the first marker is displayed in first position indication area 205 with the horizontal length and in the horizontal position as acquired in step S06.

In the following step S08, for the object that has been set as the target object, the vertical position and vertical length within the page are acquired. Then, in step S09, a second marker is displayed in second position indication area 207. Specifically, the second marker is displayed in second position indication area 207 with the vertical length and in the vertical position as acquired in step S08.

In step S10, it is determined whether a page forward instruction has been accepted. When the user inputs to input portion 115 an instruction to page forward, the page forward instruction is accepted. If the page forward instruction is accepted, the process proceeds to step S11; otherwise, the process proceeds to step S12.

In step S11, variable N is incremented by “1”, and the process return to step S03. Thereafter, the N-th page is displayed in step S03, and when an object is selected in step S04, the object is set as the target object, and a first marker for the target object is displayed in first position indication area 205 and a second marker for the target object is displayed in second position indication area 207. In this manner, a plurality of objects included in different pages can be set as the target objects, and the first and second markers corresponding respectively to the plurality of target objects can be displayed in first position indication area 205 and second position indication area 207.

If the page forward instruction is not accepted in step S10, it is determined in step S12 whether the first marker has been selected. If the first marker is selected, the process proceeds to step S13; otherwise, the process proceeds to step S14, with step S13 being skipped. In step S13, a horizontal position/length moving/changing process is executed, and the process proceeds to step S14. The horizontal position/length moving/changing process will be described later in detail.

In step S14, it is determined whether the second marker has been selected. If the second marker is selected, the process proceeds to step S15; otherwise, the process proceeds to step S16, with step S15 being skipped. In step S15, a vertical position/length moving/changing process is executed, and the process proceeds to step S16. The vertical position/length moving/changing process will be described later in detail.

In step S16, it is determined whether an end instruction has been accepted. When the user inputs an end instruction to input portion 115, the end instruction is accepted. If the end instruction is accepted, the process is finished; otherwise, the process returns to step S04.

In the event that no page forward instruction is accepted in step S10, no first marker is selected in step S12, no second marker is selected in step S14, and no end instruction is accepted in step S16, then the process returns to step S04, and steps S04 to S09 are repeated for the same page. This means that two or more objects in a single page can be set as the target objects. In this case, in the state where a plurality of objects included in a page that is a display target in the content have been set as the target objects, even in the case where only a part of that page is being displayed in content display area 203 and, hence, not all the objects are displayed in content display area 203, a first or second marker for the object that is not displayed in content display area 203 is displayed in first position indication area 205 or second position indication area 207. Accordingly, even in the case where the content includes only one page, at least one of the horizontal and vertical positions of an object not being displayed can be compared with that of an object being displayed.

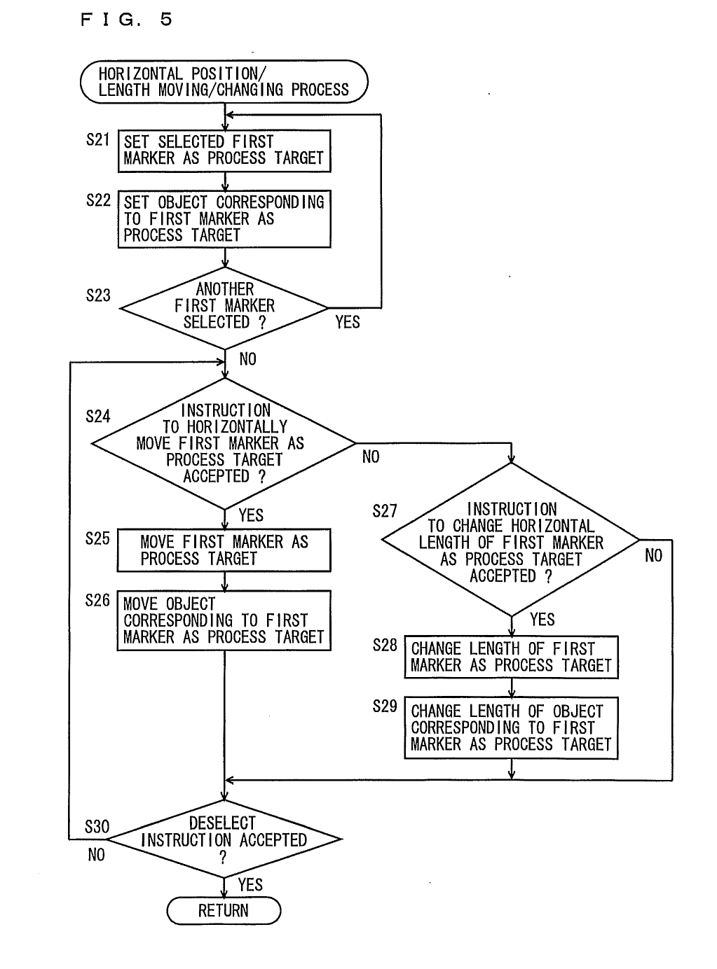

FIG. 5 is a flowchart illustrating an example of the flow of the horizontal position/length moving/changing process, which is carried out in step S13 in FIG. 4. Referring to FIG. 5, the horizontal position/length moving/changing process is executed in the state where a first marker has been selected. In step S21, the selected first marker is set as a process target. Then, an object corresponding to the first marker that has been set as the process target is set as a process target (step S22).

Next, it is determined whether another first marker in the horizontal direction has been selected (step S23). If another first marker has been selected, the process returns to step S21; otherwise, the process proceeds to step S24. In the case where the process returns to step S21, the other first marker is set as a process target, and an object corresponding to that first marker is set as a process target. As such, two or more objects may be set as the process targets.

In step S24, it is determined whether an instruction to move the first marker set as the process target in the horizontal direction has been accepted. If an instruction to horizontally move the first marker has been accepted, the process proceeds to step S25; otherwise, the process proceeds to step S27. In step S25, the first marker set as the process target is moved in accordance with the instruction. If two or more first markers have been set as the process targets, all the first markers set as the process targets are moved to a same position. In the following step S26, the object corresponding to the first marker set as the process target is moved to the horizontal position where the first marker has been moved, and the process proceeds to step S30.

Meanwhile, in step S27, it is determined whether an instruction to change the horizontal length of the first marker set as the process target has been accepted. If an instruction to change the horizontal length has been accepted, the process proceeds to step S28; otherwise, the process proceeds to step S30. In step S28, the horizontal length of the first marker set as the process target is changed in accordance with the instruction. In the case where two or more first markers have been set as the process targets, the lengths of all the first markers set as the process targets are changed to a same length.

In step S29, the horizontal length of the object corresponding to the first marker set as the process target is changed to the length identical to the length to which the first marker has been changed. The process then proceeds to step S30.

In step S30, it is determined whether a deselect instruction to release the selection has been accepted. If a deselect instruction has been accepted, the process returns to the content display process; otherwise, the process returns to step S24.

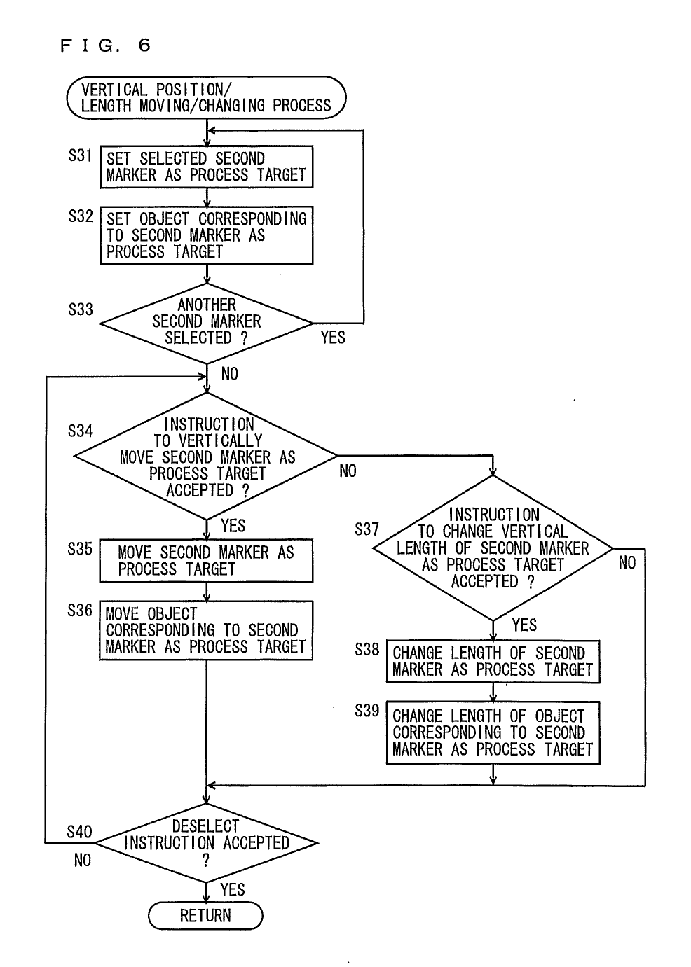

FIG. 6 is a flowchart illustrating an example of the flow of the vertical position/length moving/changing process, which is carried out in step S15 in FIG. 4. Referring to FIG. 6, the vertical position/length moving/changing process is executed in the state where a second marker has been selected. In step S31, the selected second marker is set as a process target. Then, an object corresponding to the second marker that has been set as the process target is set as a process target (step S32).

Next, it is determined whether another second marker in the vertical direction has been selected (step S33). If another second marker has been selected, the process returns to step S31; otherwise, the process proceeds to step S34. In the case where the process returns to step S31, the other second marker is set as a process target, and an object corresponding to that second marker is set as a process target. As such, two or more objects may be set as the process targets.

In step S34, it is determined whether an instruction to move the second marker set as the process target in the vertical direction has been accepted. If an instruction to vertically move the second marker has been accepted, the process proceeds to step S35; otherwise, the process proceeds to step S37. In step S35, the second marker set as the process target is moved in accordance with the instruction. If two or more second markers have been set as the process targets, all the second markers set as the process targets are moved to a same position. In the following step S36, the object corresponding to the second marker set as the process target is moved to the vertical position where the second marker has been moved, and the process proceeds to step S40.

Meanwhile, in step S37, it is determined whether an instruction to change the vertical length of the second marker set as the process target has been accepted. If an instruction to change the vertical length has been accepted, the process proceeds to step S38; otherwise, the process proceeds to step S40. In step S38, the vertical length of the second marker set as the process target is changed in accordance with the instruction. In the case where two or more second markers have been set as the process targets, the lengths of all the second markers set as the process targets are changed to a same length.

In step S39, the vertical length of the object corresponding to the second marker set as the process target is changed to the length identical to the length to which the second marker has been changed. The process then proceeds to step S40.

In step S40, it is determined whether a deselect instruction to release the selection has been accepted. If a deselect operation has been accepted, the process returns to the content display process; otherwise, the process returns to step S34.

### <First Modification of Moving/Changing Operation>

In the PC according to the above-described embodiment, the positions or the lengths of the first and second markers displayed in first position indication area 205 and second position indication area 207, respectively, are moved or changed, so as to move the position of, or change the length of, the corresponding object. The PC according to a first modification is configured such that, when a plurality of first markers or a plurality of second markers are selected as process targets, the horizontal and vertical positions of a plurality of objects corresponding to the selected first and second markers as well as the horizontal and vertical lengths of the objects can be changed collectively.

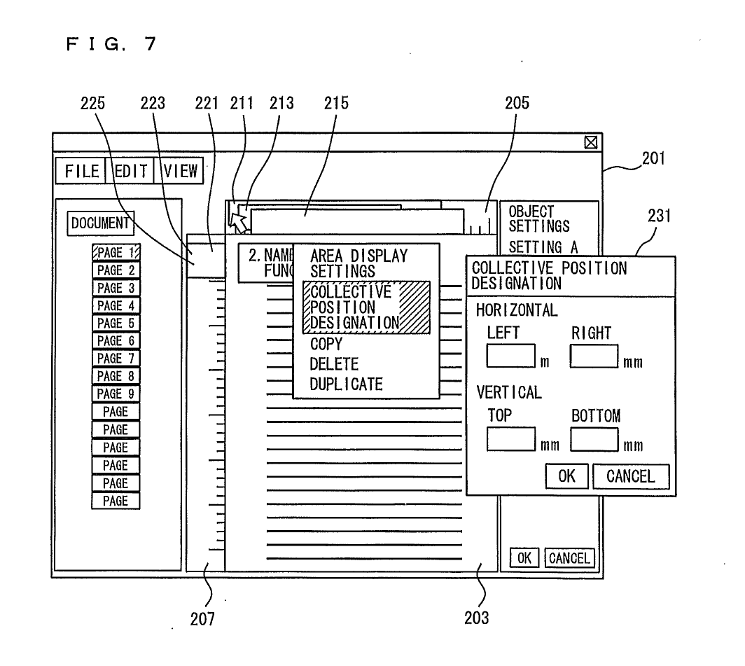

FIG. 7 shows an example of a collective change instructing screen. Referring to FIG. 7, a collective change instructing screen 231 is displayed on display screen 201 in an overlapped manner. Collective change instructing screen 231 includes areas for setting left and right positions in the horizontal direction by coordinate values, and areas for setting upper and lower positions in the vertical direction by coordinate values. When a user inputs to input portion 115 a coordinate value of the left end in the horizontal direction, a coordinate value of the right end in the horizontal direction, a coordinate value of the upper end in the vertical direction, and a coordinate value of the lower end in the vertical direction, those values are input into the PC. The left and right coordinate values in the horizontal direction and the upper and lower coordinate values in the vertical direction are input into first marker moving portion 21, second marker moving portion 23, first marker length changing portion 25, and second marker length changing portion 27, and the horizontal and vertical positions and lengths of the first and second markers are changed. Correspondingly, in first object position changing portion 31, second object position changing portion 33, first object length changing portion 35, and second object length changing portion 37, the horizontal and vertical positions and lengths of the objects corresponding to the selected first and second markers are changed. In the PC according to the first modification, the positions and sizes of a plurality of objects within the corresponding pages can be changed with a single operation, whereby the operations can be simplified.

### <Second Modification of Moving/Changing Operation>

In a second modification of the moving/changing operation, a plurality of grid lines are arranged at predetermined intervals in first position indication area 205 and second position indication area 207, so as to allow the first and second markers to be moved only onto the positions on the grid lines. More specifically, in the case where the position designated by the user is not on the grid line, it is determined that the position on the grid line that is closest to the designated position has been designated. Thus, even in the case where the positions of a plurality of first or second markers designated by the user are slightly different from each other, they are automatically adjusted to the positions on the grid lines. This facilitates the operations for setting a plurality of first or second markers in a same position.

### <First Modification of Display of First or Second Markers>

In PC 100 in the above-described embodiment, first markers 211, 213, and 215 are displayed in first position indication area 205 in an overlapped manner, and second markers 221, 223, and 225 are displayed in second position indication area 207 in an overlapped manner. In a first modification of display, it is configured such that a plurality of first markers or a plurality of second markers are displayed in different colors.

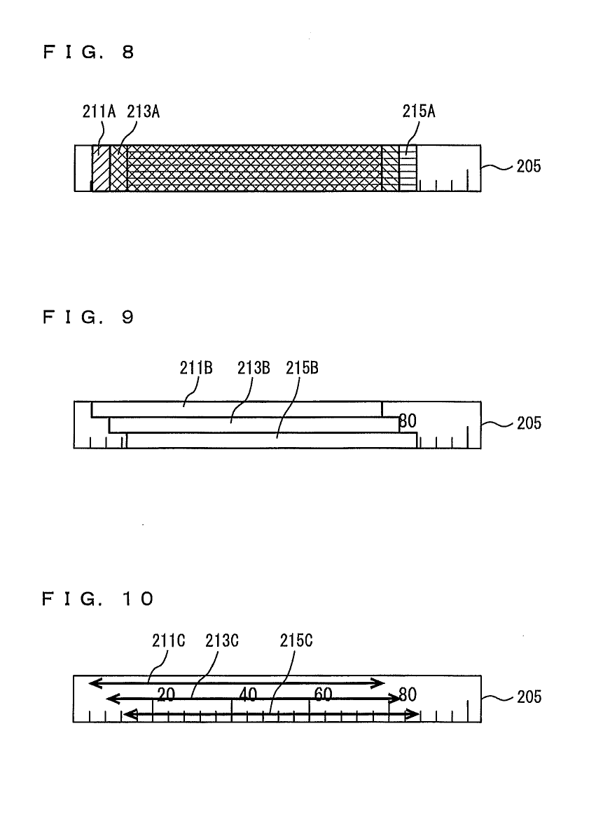

FIG. 8 shows an example of the first position indication area in which a plurality of first markers are displayed in different colors. Referring to FIG. 8, first markers 211A, 213A, and 215A are displayed in red, blue, and green, respectively, in first position indication area 205. Here, the hatching from upper right to lower left indicates red, the hatching from upper left to lower right indicates blue, and the hatching in the horizontal direction indicates green.

When the markers are displayed in different colors, while the overlapping portions are displayed in darker colors, the non-overlapping portions are displayed in the originally assigned colors. Accordingly, it can be determined, by checking the colors, whether the first markers or the second markers are arranged in the same position or in the different positions.

### <Second Modification of Display of First or Second Markers>

In a second modification of display, first markers 211, 213, and 215 are displayed in first position indication area 205 so as not to overlap each other, and second markers 221, 223, and 225 are displayed in second position indication area 207 so as not to overlap each other. When first markers 211, 213, and 215 and second markers 221, 223, and 225 are arranged not to overlap each other, it is readily possible to confirm the positions and lengths of the respective markers.

FIG. 9 shows an example of the first position indication area in which a plurality of first markers are displayed so as not to overlap each other. First markers 211B, 213B, and 215B are shown by rectangles, which are arranged in a vertical direction.

FIG. 10 shows another example of the first position indication area in which first markers are displayed so as not to overlap each other. First markers 211C, 213C, and 215C are shown by double-headed arrows, which are arranged in a vertical direction.

As described above, according to PC 100 of the present embodiment, irrespective of whether or not a target object selected from among a plurality of objects included in content is being displayed in content display area 203, markers indicating the position in the content where the target object is arranged are displayed in position indication areas 205 and 207 which are provided for indicating positions in the content and provided separately from content display area 203. For example, as shown in FIG. 3, first marker 211 and second marker 221 corresponding to the first object included in the first page, which is not being displayed in content display area 203, and first marker 215 and second marker 225 corresponding to the third object included in the third page, which is not being displayed in content display area 203 either, are displayed in first position indication area 205 and second position indication area 207, respectively. Accordingly, the positions within the content of the first and third objects, which are not being displayed, can be shown together with the position of the second object, which is being displayed.

In the case where the first and third objects are arranged in target pages (here, first and third pages) other than the second page now being displayed in content display area 203, first markers 211, 215 and second markers 221, 225 indicating the positions of the first and third objects in the first and third pages, respectively, are displayed in first position indication area 205 and second position indication area 207, which show the positions within the second page now being displayed. That is, for the objects included in the pages other than the page now being displayed, their positions within the pages are displayed. This makes it possible, for a plurality of objects included in different pages, to confirm their positions within the corresponding pages.

Further, when the first marker, 211, 213, or 215, displayed in first position indication area 205 is moved, the horizontal position of the corresponding object is changed to the position of the first marker which has been moved. When the second marker, 221, 223, or 225, displayed in second position indication area 207 is moved, the vertical position of the corresponding object is changed to the position of the second marker which has been moved. Accordingly, it is possible to change the position, within the content, of the object that is not being displayed.

When a plurality of objects, e.g. first, second, and third objects, are set as the target objects, a plurality of first markers 211, 213, 215 and a plurality of second markers 221, 223, and 225 corresponding respectively to the first, second, and third objects are displayed in first position indication area 205 and second position indication area 207, respectively. As such, the positions within the content where a plurality of objects, e.g. the first, second, and third objects, are arranged can be displayed at the same time.

Furthermore, when first markers 211, 213, and 215 are moved, the horizontal positions of the first, second, and third objects corresponding respectively to first markers 211, 213, and 215 are changed to the positions of first markers 211, 213, and 215 which have been moved. When second markers 221, 223, and 225 are moved, the vertical positions of the first, second, and third objects corresponding respectively thereto are changed to the positions of second markers 221, 223, and 225 which have been moved. As such, it is possible to change the positions of a plurality of objects with a single operation.

First markers 211, 213, 215 and second markers 221, 223, 225 are displayed in first position indication area 205 and second position indication area 207 so as to have sizes identical to the sizes of the first, second, and third objects, respectively. As such, it is possible to display the sizes of the first and third objects which are not being displayed.

Furthermore, first markers 211, 213, and 215 corresponding respectively to the first through third objects are displayed in first position indication area 205 so as to have horizontal lengths identical to those of the first through third objects. Second markers 221, 223, and 225 corresponding respectively to the first through third objects are displayed in second position indication area 207 so as to have vertical lengths identical to those of the first through third objects. As such, the sizes of the first through third objects can be displayed using the horizontal and vertical lengths thereof.

When the horizontal length of the first marker, 211, 213, or 215, is changed, the horizontal length of the corresponding one of the first through third objects is changed to the changed length of the marker. When the vertical length of the second marker, 221, 223, or 225, is changed, the vertical length of the corresponding one of the first through third objects is changed to the changed length of the marker. This makes it possible to change the sizes of the first and third objects that are not being displayed.

Further, in the case where a plurality of objects, e.g. first, second, and third objects, are set as target objects, a plurality of first markers 211, 213, and 215 corresponding respectively to the first through third objects are displayed in first position indication area 205 so as to have the lengths identical to the horizontal lengths of the corresponding objects, and a plurality of second markers 221, 223, and 225 corresponding respectively to the first through third objects are displayed in second position indication area 207 so as to have the lengths identical to the vertical lengths of the corresponding objects. Accordingly, the sizes of the plurality of objects arranged within the content can be displayed at the same time.

Furthermore, when the lengths of the plurality of first markers 211, 213, and 215 are changed, the horizontal lengths of the first, second, and third objects are changed to the lengths identical to the changed lengths of first markers 211, 213, and 215. When the lengths of the plurality of second markers 221, 223, and 225 are changed, the vertical lengths of the first, second, and third objects are changed to the lengths identical to the changed lengths of second markers 221, 223, and 225. Accordingly, the sizes of a plurality of objects can be changed with simple operations.

While PC 100 has been described as an example of the content display apparatus in the above embodiment, the present invention may of course be understood as a content display method for performing the content display process shown in FIGS. 4 to 6, or a content display program for causing a computer to execute the content display method.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A content display apparatus comprising:
a content display portion to display part of content in a display area;
a setting portion to set an object selected from among a plurality of objects included in said content as a target object; and
a marker display portion to display, in a position indication area, a marker indicating a position within said content where said target object is arranged, irrespective of whether or not said target object is being displayed in said display area, the position indication area being provided separately from said display area and indicating positions within said content.

2. The content display apparatus according to claim 1, wherein
in the case where said content includes a plurality of pages, the position within said content where said target object is arranged indicates a position within a page where said target object is arranged, and
in the case where said target object is arranged in a target page that is other than a page being displayed in said display area, said marker display portion displays a marker indicating a position within said target page where said target object is arranged, in the position indication area indicating positions within said page being displayed.

3. The content display apparatus according to claim 1, wherein
in order to indicate a position within the content by a position in a first direction and a position in a second direction crossing the first direction, said position indication area includes a first position indication area corresponding to the first direction and a second position indication area corresponding to the second direction, and
said marker display portion displays a first marker indicating a position in the first direction of said target object in said first position indication area, and displays a second marker indicating a position in the second direction of said target object in said second position indication area.

4. The content display apparatus according to claim 3, further comprising:
a first marker moving portion to move, within said first position indication area, the first marker displayed in said first position indication area;
a first object position changing portion, in response to an event that said first marker is moved by said first marker moving portion, to change the position in the first direction of said target object in correspondence with the moved position of said first marker, without changing the position in the second direction of said target object;
a second marker moving portion to move, within said second position indication area, the second marker displayed in said second position indication area; and
a second object position changing portion, in response to an event that said second marker is moved by said second marker moving portion, to change the position in the second direction of said target object in correspondence with the moved position of said second marker, without changing the position in the first direction of said target object.

5. The content display apparatus according to claim 3, wherein in the case where a plurality of objects are selected from among said plurality of objects and set as the target objects by said setting portion, said marker display portion displays in said first position indication area a plurality of said first markers corresponding respectively to said plurality of target objects, and displays in said second position indication area a plurality of said second markers corresponding respectively to said plurality of target objects.

6. The content display apparatus according to claim 5, further comprising:
a first marker moving portion to move, within said first position indication area, at least one of said plurality of first markers displayed in said first position indication area;
a first object position changing portion, in response to an event that said at least one first marker is moved by said first marker moving portion, for each of said at least one target object among said plurality of target objects corresponding respectively to said at least one first marker that has been moved, to change the position in the first direction of said target object in correspondence with the moved position of said first marker, without changing the position in the second direction of said target object;
a second marker moving portion to move, within said second position indication area, at least one of said plurality of second markers displayed in said second position indication area; and
a second object position changing portion, in response to an event that said at least one second marker is moved by said second marker moving portion, for each of said at least one target object among said plurality of target objects corresponding respectively to said at least one second marker that has been moved, to change the position in the second direction of said target object in correspondence with the moved position of said second marker, without changing the position in the first direction of said target object.

7. The content display apparatus according to claim 1, wherein
said marker also indicates a size of said target object, and
said marker display portion displays said marker in said position indication area, with a size identical to a size of said target object.

8. The content display apparatus according to claim 7, wherein
in order to indicate a position within the content by a position in a first direction and a position in a second direction crossing the first direction, said position indication area includes a first position indication area corresponding to the first direction and a second position indication area corresponding to the second direction, and
said marker display portion displays a first marker indicating a position in the first direction of said target object, in said first position indication area, with a length identical to a length in the first direction of said target object, and displays a second marker indicating a position in the second direction of said target object, in said second position indication area, with a length identical to a length in the second direction of said target object.

9. The content display apparatus according to claim 8, further comprising:
a first marker length changing portion to change, within said first position indication area, a length in the first direction of the first marker being displayed in said first position indication area;
a first object length changing portion, in response to an event that the length in the first direction of said first marker is changed by said first marker length changing portion, to change the length in the first direction of said target object in correspondence with the changed length of said first marker, without changing the length in the second direction of said target object;
a second marker length changing portion to change, within said second position indication area, a length in the second direction of the second marker being displayed in said second position indication area; and
a second object length changing portion, in response to an event that the length in the second direction of said second marker is changed by said second marker length changing portion, to change the length in the second direction of said target object in correspondence with the changed length of said second marker, without changing the length in the first direction of said target object.

10. The content display apparatus according to claim 7, wherein
in order to indicate a position within the content by a position in a first direction and a position in a second direction crossing the first direction, said position indication area includes a first position indication area corresponding to the first direction and a second position indication area corresponding to the second direction, and
in the case where a plurality of objects are selected from among said plurality of objects and set as the target objects by said setting portion, said marker display portion displays a plurality of first markers corresponding respectively to said plurality of target objects, in said first position indication area, each with a length identical to a length in the first direction of the corresponding target object, and displays a plurality of second markers corresponding respectively to said plurality of target objects, in said second position indication area, each with a length identical to a length in the second direction of the corresponding target object.

11. The content display apparatus according to claim 10, further comprising:
a first marker length changing portion to change, within said first position indication area, a length in the first direction of at least one of said plurality of first markers displayed in said first position indication area;
a first object length changing portion, in response to an event that the length of said at least one first marker is changed by said first marker length changing portion, for each of said at least one target object among said plurality of target objects corresponding respectively to said at least one first marker whose length has been changed, to change the length in the first direction of said target object in correspondence with the changed length of said first marker, without changing the length in the second direction of said target object;
a second marker length changing portion to change, within said second position indication area, a length in the second direction of at least one of said plurality of second markers displayed in said second position indication area; and
a second object length changing portion, in response to an event that the length of said at least one second marker is changed by said second marker length changing portion, for each of said at least one target object among said plurality of target objects corresponding respectively to said at least one second marker whose length has been changed, to change the length in the second direction of said target object in correspondence with the changed length of said second marker, without changing the length in the first direction of said target object.

12. A content display method comprising the steps of:
displaying part of content in a display area;
setting an object selected from among a plurality of objects included in said content as a target object; and
displaying, in a position indication area, a marker indicating a position within said content where said target object is arranged, irrespective of whether or not said target object is being displayed in said display area, the position indication area being provided separately from said display area and indicating positions within said content.

13. The content display method according to claim 12, wherein
in the case where said content includes a plurality of pages, the position within said content where said target object is arranged indicates a position within a page where said target object is arranged, and
in the case where said target object is arranged in a target page that is other than a page being displayed in said display area, said step of displaying a marker includes the step of displaying the marker indicating the position within said target page where said target object is arranged, in the position indication area indicating positions within said page being displayed.

14. The content display method according to claim 12, wherein
in order to indicate a position within the content by a position in a first direction and a position in a second direction crossing the first direction, said position indication area includes a first position indication area corresponding to the first direction and a second position indication area corresponding to the second direction, and
said step of displaying a marker includes the steps of
displaying in said first position indication area a first marker indicating a position in the first direction of said target object, and
displaying in said second position indication area a second marker indicating a position in the second direction of said target object.

15. The content display method according to claim 12, wherein
said marker also indicates a size of said target object, and
said step of displaying a marker includes the step of displaying said marker, in said position indication area, with a size identical to a size of said target object.

16. A content display program embodied on a computer readable medium, the program causing a computer to perform the steps of:
displaying part of content in a display area;
setting an object selected from among a plurality of objects included in said content as a target object; and
displaying, in a position indication area, a marker indicating a position within said content where said target object is arranged, irrespective of whether or not said target object is being displayed in said display area, the position indication area being provided separately from said display area and indicating positions within said content.

17. The content display program according to claim 16, wherein
in the case where said content includes a plurality of pages, the position within said content where said target object is arranged indicates a position within a page where said target object is arranged, and
in the case where said target object is arranged in a target page that is other than a page being displayed in said display area, said step of displaying a marker includes the step of displaying the marker indicating the position within said target page where said target object is arranged, in the position indication area indicating positions within said page being displayed.

18. The content display program according to claim 16, wherein
in order to indicate a position within the content by a position in a first direction and a position in a second direction crossing the first direction, said position indication area includes a first position indication area corresponding to the first direction and a second position indication area corresponding to the second direction, and
said step of displaying a marker includes the steps of
displaying in said first position indication area a first marker indicating a position in the first direction of said target object, and
displaying in said second position indication area a second marker indicating a position in the second direction of said target object.

19. The content display program according to claim 16, wherein
said marker also indicates a size of said target object, and
said step of displaying a marker includes the step of displaying said marker, in said position indication area, with a size identical to a size of said target object.
